(19) United States
(12) Patent Application Publication
(10) Pub. No.: US 2021/0173193 A1
(43) Pub. Date: Jun. 10, 2021

(54) OBSERVATION DEVICE AND OBSERVATION METHOD

(71) Applicant: OLYMPUS CORPORATION, Tokyo (JP)

(72) Inventor: Yoko ABE, Tokyo (JP)

(73) Assignee: OLYMPUS CORPORATION, Tokyo (JP)

(21) Appl. No.: 17/182,460

(22) Filed: Feb. 23, 2021

Related U.S. Application Data
(63) Continuation-in-part of application No. PCT/JP2018/036729, filed on Oct. 1, 2018.

(51) Int. Cl. G02B 21/36

(52) U.S. Cl. CPC G02B 21/361; G02B 21/368

(57) ABSTRACT

An observation device includes: a camera that acquires an observation image by photographing a subject; one or more processors comprising hardware, the one or more processors being configured to: generate a reference image by performing image processing on the acquired observation image for eliminating an abnormality in the observation image; and a display that displays the generated reference image and the observation image in a switching manner.

### CROSS-REFERENCE TO RELATED APPLICATIONS

This is a continuation-in-part of International Application PCT/JP2018/036729, with an international filing date of Oct. 1, 2018, which is hereby incorporated by reference herein in its entirety.

### TECHNICAL FIELD

The present invention relates to observation devices and observation methods.

### BACKGROUND ART

A known subject inspection process involves comparing a preliminarily-stored reference image not including an abnormality with a newly-acquired observation image so as to check whether or not there is an abnormality, such as a problem in the shape (e.g., see Patent Literature 1).

Patent Literature 1 discloses a method involving storing the observation conditions when the reference image is acquired, so as to reproduce the same observation conditions when the observation image is acquired, thereby facilitating comparison between the observation image and the reference image.

### CITATION LIST

### Patent Literature

### {PTL 1}

### Japanese Unexamined Patent Application, Publication No. 2003-066339

### SUMMARY OF INVENTION

An aspect of the present invention is directed to an observation device including: a photographing unit that acquires an observation image by photographing a subject; a reference image generator that generates a reference image, in which an abnormality has been eliminated as compared with the observation image, based on the acquired observation image; and a display unit that displays the generated reference image and the observation image in a switching manner.

Another aspect of the present invention is directed to an observation device including: a photographing unit that acquires an observation image by photographing a subject; a reference image generator that generates a reference image, in which an abnormality has been eliminated as compared with the observation image, based on the acquired observation image; a difference image generator that generates a difference image between the generated reference image and the observation image; and a display unit that displays the generated difference image and the observation image in a switching manner.

Another aspect of the present invention is directed to an observation device including: a photographing unit that acquires an observation image by photographing a subject; a reference image generator that generates a reference image, in which an abnormality has been eliminated as compared with the observation image, based on the acquired observation image; a difference calculator that calculates a magnitude of a difference between the generated reference image and the observation image; an image corrector that generates a correction image by adjusting a color attribute or brightness of the reference image based on the calculated magnitude of the difference; and a display unit that displays the generated correction image and the observation image in a switching manner.

Another aspect of the present invention provides an observation method including: acquiring an observation image by photographing a subject; generating a reference image by performing image processing on the acquired observation image for eliminating an abnormality in the observation image; and displaying the generated reference image and the observation image in a switching manner.

Another aspect of the present invention provides an observation method including: acquiring an observation image by photographing a subject; generating a reference image, in which an abnormality has been eliminated as compared with the observation image, based on the acquired observation image; generating a difference image between the generated reference image and the observation image; and displaying the generated difference image and the observation image in a switching manner.

Another aspect of the present invention provides an observation method including: acquiring an observation image by photographing a subject; generating a reference image, in which an abnormality has been eliminated as compared with the observation image, based on the acquired observation image; calculating the magnitude of a difference between the generated reference image and the observation image; generating a correction image by adjusting a color attribute or brightness of the reference image based on the calculated magnitude of the difference; and displaying the generated correction image and the observation image in a switching manner.

### BRIEF DESCRIPTION OF DRAWINGS

FIG. 1 is a block diagram illustrating an observation device according to a first embodiment of the present invention.

FIG. 2 is a flowchart illustrating an observation method using the observation device in FIG. 1.

FIG. 3 is a block diagram illustrating a first modification of the observation device in FIG. 1.

FIG. 4 is a block diagram illustrating a second modification of the observation device in FIG. 1.

FIG. 5 is a block diagram illustrating an observation device according to a second embodiment of the present invention.

FIG. 6 is a flowchart illustrating an observation method using the observation device in FIG. 5.

FIG. 7 is a flowchart illustrating operation for setting a display method in the flowchart in FIG. 6.

FIG. 8 is a flowchart illustrating a first modification of the observation method in FIG. 6.

FIG. 9 is a flowchart illustrating a part of a second modification of the observation method in FIG. 6.

FIG. 10 is a flowchart of a part continuing from the flowchart in FIG. 9.

FIG. 11 is a flowchart illustrating a third modification of the observation method in FIG. 6.

FIG. 12 is a flowchart illustrating operation for setting the display method in the flowchart in FIG. 6.

FIG. 13 is a flowchart illustrating a fourth modification of the observation method in FIG. 6.

### DESCRIPTION OF EMBODIMENTS

An observation device 1 and an observation method according to a first embodiment of the present invention will be described below with reference to the drawings.

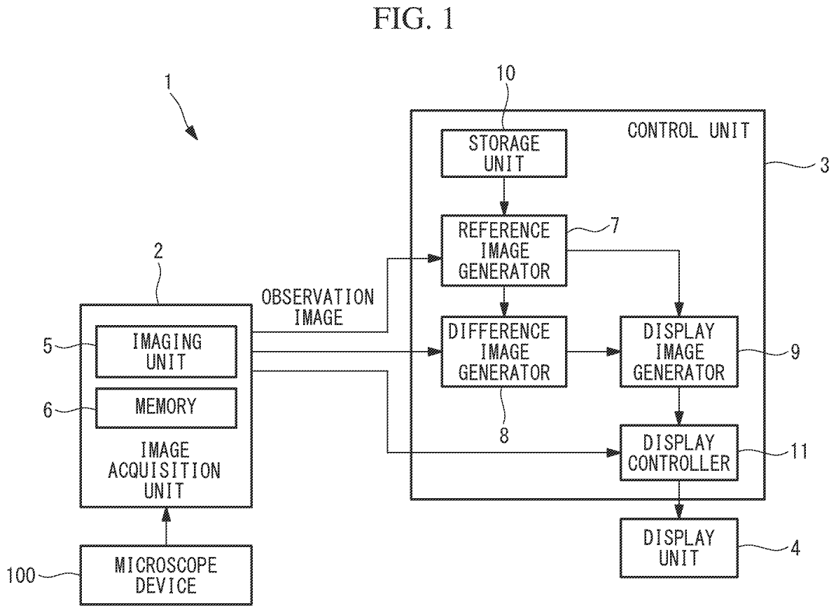

As shown in FIG. 1, the observation device 1 according to this embodiment includes an image acquisition unit (photographing unit) 2 that acquires an observation image by photographing light collected by a microscope device 100, a control unit 3 that processes the acquired observation image, and a display unit 4 that displays the image processed by the control unit 3. The control unit 3 is constituted of a processor and a memory.

The microscope device 100 moves a stage, on which a subject is placed, in accordance with an operation performed by a user, and forms an image of the subject within an observation visual field based on predetermined photographing conditions. The microscope device used is not limited to a type that has a stage and may be a microscope device with any structure that allows for observation of a subject by shifting the visual field.

The image acquisition unit 2 is a camera attached to the microscope device 100 and includes an imaging unit 5 that photographs an image of a sample formed within the observation visual field by the microscope device 100 so as to acquire a live image or a still image as an observation image, and also includes a memory 6 that stores the acquired observation image.

The control unit 3 includes a reference image generator 7, a difference image generator 8, a display image generator 9, a storage unit 10, and a display controller (display adjuster) 11.

The reference image generator 7 is provided with a network that preliminarily learns a pattern (correct pattern) of a non-abnormal subject and that has extracted a parameter with which the correct pattern can be reproduced. For establishing the network, an auto encoder is used. The parameter obtained by the auto encoder is stored in the storage unit 10.

If the network that has learned the correct pattern by using the auto encoder receives an observation image that includes an abnormality, such as a scratch, image restoration is performed by using a parameter of a previously-learned correct pattern, thereby generating a reference image in which the abnormality has been eliminated as compared with the observation image. If the observation image received does not include an abnormality, the observation image is directly output as a reference image.

The difference image generator 8 receives the observation image and the reference image so as to generate a difference image between the observation image and the reference image. The difference image is obtained by scanning a sliding window and calculating a mean square error between the observation image and the reference image.

The display image generator 9 calculates a sum of mean square errors obtained by the difference image generator 8, and selects the reference image as a display image if the sum is larger than a predetermined threshold value or selects the difference image as a display image if the sum is smaller than or equal to the predetermined threshold value.

The display controller 11 receives the observation image acquired by the imaging unit 5 and the display image generated by the display image generator 9, and outputs the two images to the display unit 4 while switching therebetween a predetermined number of times at predetermined time intervals. The predetermined number of times the display is switched in the display unit 4 is preferably set to a plural value rather than a singular value.

The observation method using the observation device 1 according to this embodiment having the above-described configuration will be described below.

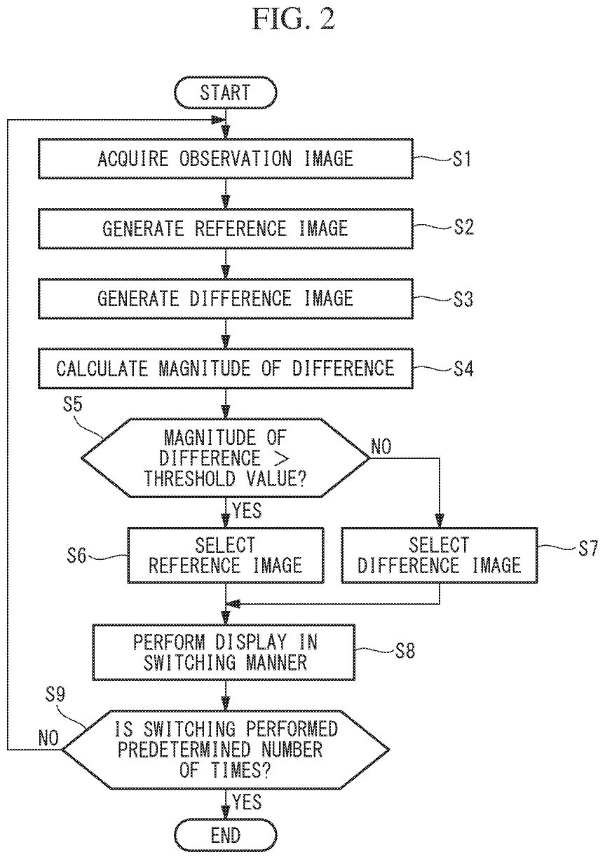

As shown in FIG. 2, the observation method according to this embodiment involves using the image acquisition unit 2 to photograph a subject focused by the microscope device 100 so as to acquire an observation image (step S1), and causing the reference image generator 7 to generate a reference image, in which an abnormality has been eliminated as compared with the observation image, based on the acquired observation image (step S2).

The reference image is generated based on the observation image by preliminarily learning a correct pattern of a non-abnormal subject and inputting the observation image to a network that has extracted a parameter with which the correct pattern can be reproduced.

Then, the difference image generator 8 generates a difference image between the generated reference image and the observation image (step S3). The display image generator 9 calculates the magnitude of a difference based on the difference image (step S4) and determines whether or not the magnitude of the difference is larger than a predetermined threshold value (step S5).

If the determination result indicates that the magnitude of the difference is larger than the predetermined threshold value, the reference image is selected as a display image (step S6). If the determination result indicates that the magnitude of the difference is smaller than or equal to the predetermined threshold value, the difference image is selected as a display image (step S7). The display controller 11 performs display while switching between the observation image and the display image at predetermined time intervals (step S8). Then, it is determined whether or not the switching between the observation image and the display image is performed a predetermined number of times (step S9). If the switching has not been performed the predetermined number of times, the process from step S1 is repeated. If the switching has been performed the predetermined number of times, the process ends.

The observation device 1 and the observation method according to this embodiment involve comparing an observation image with a reference image created in advance, so as to generate, from the acquired observation image, a reference image in which an abnormality has been eliminated as compared with the observation image, unlike a method involving detecting an abnormality in the observation image, thereby matching all of the photographing conditions, such as the size and the position of the subject as well as an optical system and a light source to be used. Specifically, the observation device 1 and the observation method according to this embodiment are advantageous in that the need for adjusting the photographing conditions can be eliminated when an observation image and a reference image are to be acquired, and that the observer can be simply and accurately be notified of a location where an abnormality has occurred in a subject.

If the difference between the observation image and the reference image is large, the reference image is selected as a display image, and the observation image and the reference image are displayed in a switching manner. If the difference is large, the observation image and the reference image, which are different from each other only in terms of whether or not there is an abnormality, are displayed in a switching manner, so that the user can readily recognize an abnormality by utilizing persistence of vision.

On the other hand, if the difference between the observation image and the reference image is small, the difference image is selected as a display image, and the observation image and the difference image are displayed in a switching manner. If the difference is small, there is a high possibility in which an abnormality may be overlooked. Therefore, the difference image that directly indicates the difference is displayed, so that the user is prevented from overlooking an abnormality.

Furthermore, by performing the switching between the observation image and the display image a plurality of times, an abnormality can be recognized more accurately.

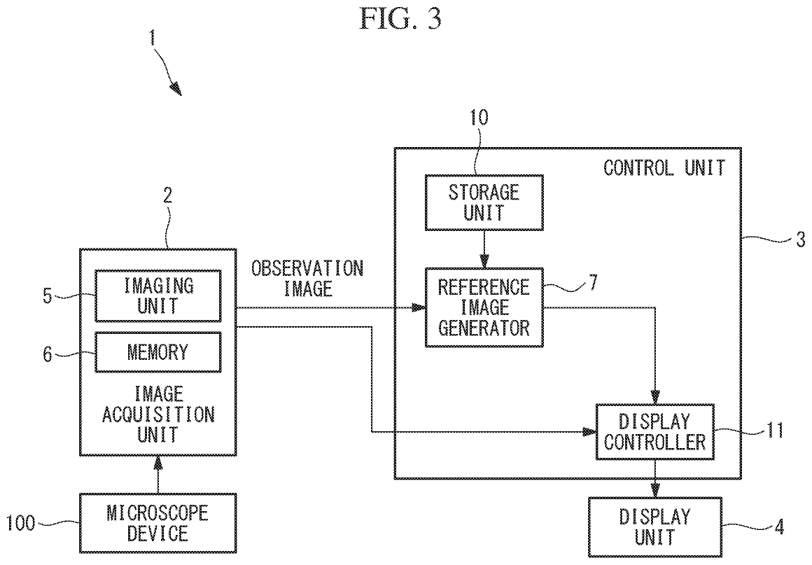

In this embodiment, the control unit 3 includes the difference image generator 8 and the display image generator 9. Alternatively, as shown in FIG. 3, the control unit 3 may include the reference image generator 7, the storage unit 10, and the display controller 11, may cause the reference image generator 7 to generate a reference image from an observation image, and may cause the display controller 11 to output the observation image and the reference image to the display unit 4 while switching between the two images a plurality of times.

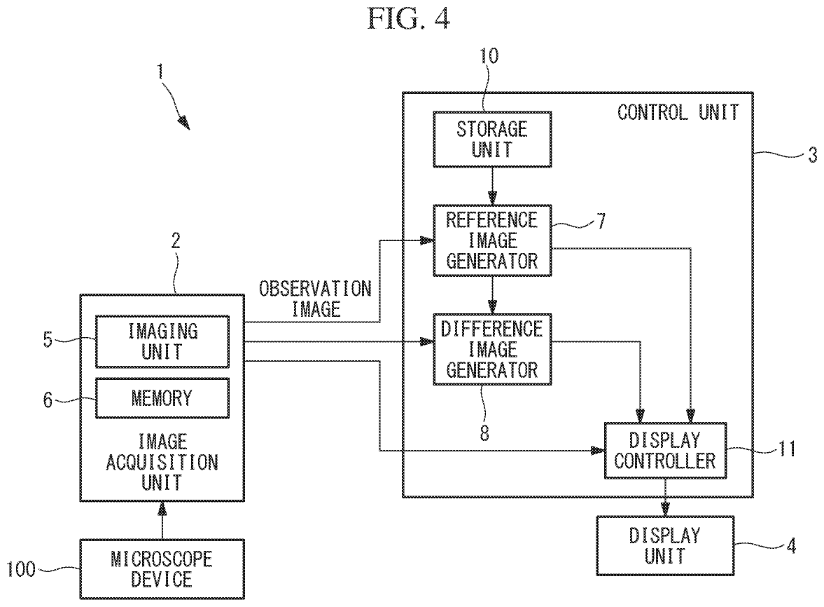

As another alternative, the display image generator 9 does not have to be provided, as shown in FIG. 4. In this case, the display controller 11 may output the observation image, the reference image, and the difference image to the display unit 4 while periodically switching among the images.

Furthermore, although a learning process using a correct pattern is preliminarily performed to establish a network that has extracted a parameter with which the correct pattern can be reproduced, pretreatment using conventional image processing, such as pattern matching involving area extraction, may be performed on a subject not having a repetitive structure. Normally, a normalization, standardization, decorrelation, or whitening process is performed as pretreatment since improvements in the generalization performance and the learning speed can be expected by eliminating deviations included in learning data, but the pretreatment is not limited to the aforementioned processes.

As an alternative to the use of a learned network that has preliminarily undergone a learning process prior to observation, the user may designate an observation subject immediately prior to observation, and the learning process may be subsequently executed.

As an alternative to the selection of the display image based on the magnitude of the difference, the user may be allowed to make the selection by using a user interface.

Furthermore, the user may be allowed to freely select the start and stoppage of the displaying of images in a switching manner, or may be allowed to change the display image.

As an alternative to the above example where the reference image is generated by preliminarily learning a correct pattern of a non-abnormal subject and inputting an observation image to a network that has extracted a parameter with which the correct pattern can be reproduced, the reference image may be generated by eliminating an abnormality from the observation image by using existing image processing, such as an inpainting technique using the fast marching method.

Next, an observation device 21 according to a second embodiment of the present invention will be described below with reference to the drawings.

In this embodiment, components identical to the components of the observation device 1 according to the first embodiment described above are given the same reference signs, and descriptions thereof will be omitted.

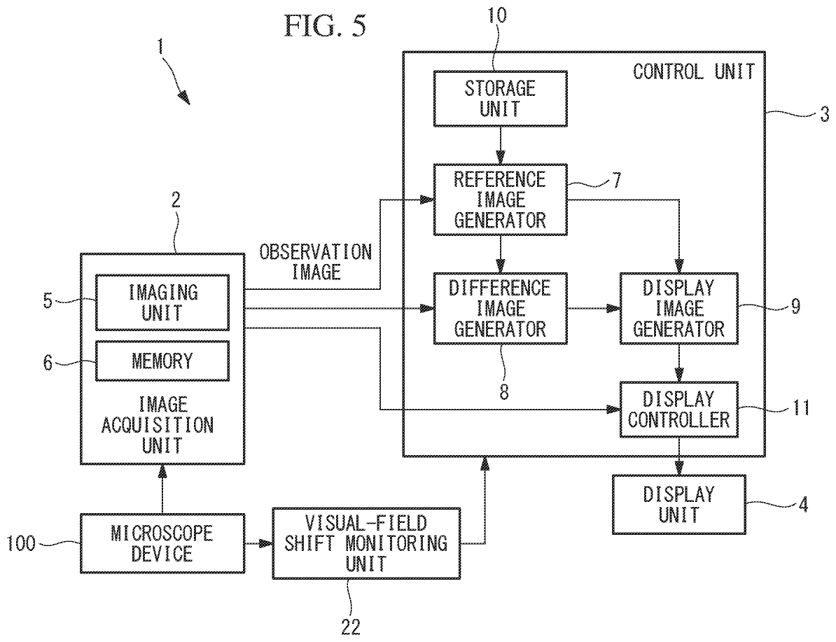

As shown in FIG. 5, the observation device 21 according to this embodiment includes a visual-field shift monitoring unit (visual-field shift-status detector) 22 that monitors a stoppage and a stoppage time period of the visual field based on stage position information detected by a sensor, such as an encoder, provided in the microscope device 100.

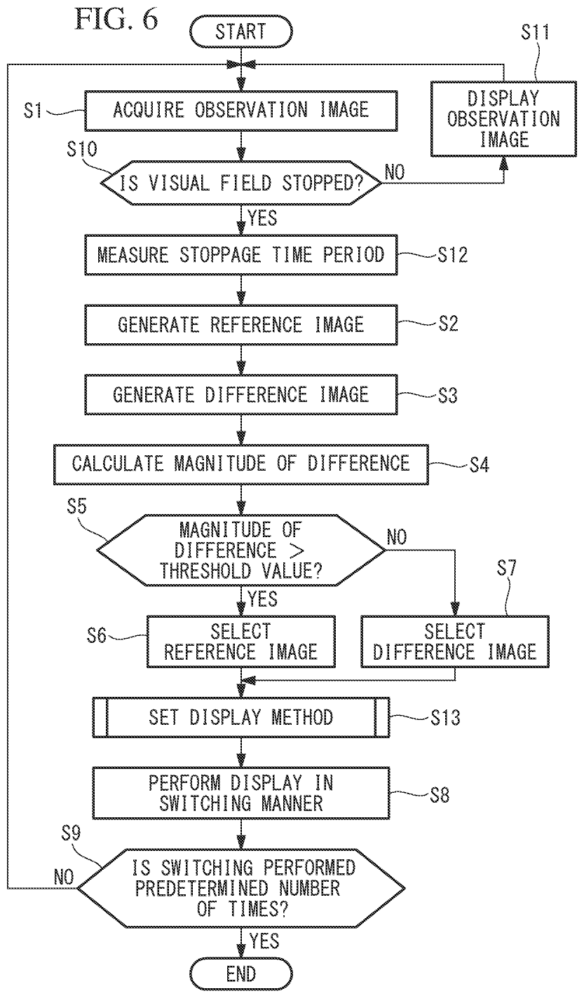

As shown in FIG. 6, the visual-field shift monitoring unit 22 acquires an observation image (step S1). Then, the visual-field shift monitoring unit 22 determines whether or not the visual field is stopped (step S10). If stoppage of the visual field is detected, the visual-field shift monitoring unit 22 measures the stoppage time period (step S12) and causes the control unit 3 to start generating a reference image, a difference image, and a display image and to display the observation image and the display image in a switching manner. In a state where stoppage of the visual field is not detected, the visual-field shift monitoring unit 22 commands the control unit 3 to display the observation image on the display unit 4 (step S11), and executes the process from step S1.

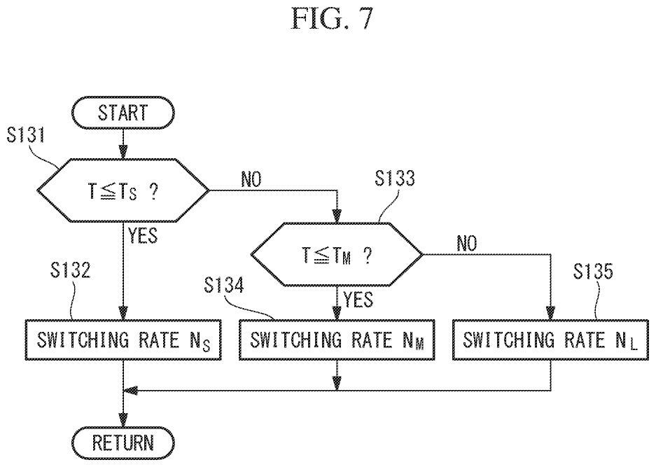

When the display controller 11 receives information about the stoppage time period from the visual-field shift monitoring unit 22, the display controller 11 sets a display method in accordance with the length of the stoppage time period (step S13). In detail, as shown in FIG. 7, it is determined whether or not a stoppage time period T is smaller than or equal to a first threshold value Tₛ (step S131). If the stoppage time period T is smaller than or equal to the first threshold value Tₛ, the display controller 11 switches between the observation image and the display image at a switching rate Nₛ (step S132). If the stoppage time period T is greater than the first threshold value Tₛ, it is determined whether or not the stoppage time period T is smaller than or equal to a second threshold value T_{M} (step S133). If the stoppage time period T is smaller than or equal to the second threshold value T_{M}, the display controller 11 switches between the observation image and the display image at a switching rate N_{M} (step S134). If the stoppage time period T is greater than the second threshold value T_{M}, the observation image and the display image are switched at a switching rate N_{L} higher than the switching rate N_{M} (step S135).

The stoppage time period of the visual field is related to the ease of determinability with respect to a sense of discomfort received due to a difference between an abnormality, such as a scratch, in a subject in an observation visual field and an assumed correct pattern. A case where the stoppage time period is short corresponds to a state where an abnormality can be found relatively easily or a state where it can be readily determined whether or not there is an abnormality.

On the other hand, a case where the stoppage time period is long corresponds to a state where there is a minor scratch or a defect or a state where the determination of whether or not there is an abnormality is difficult.

The observation device 21 according to this embodiment performs the display in a switching manner at a high rate so that an after-image remains longer with increasing stoppage time period, thereby achieving improved conspicuity.

The switching method described above is merely an example. For example, in a state where the stoppage time period is long and the determination is difficult, a user-friendly setting may be possible, such as first performing the display in a switching manner at a high rate and then temporarily reducing the switching rate.

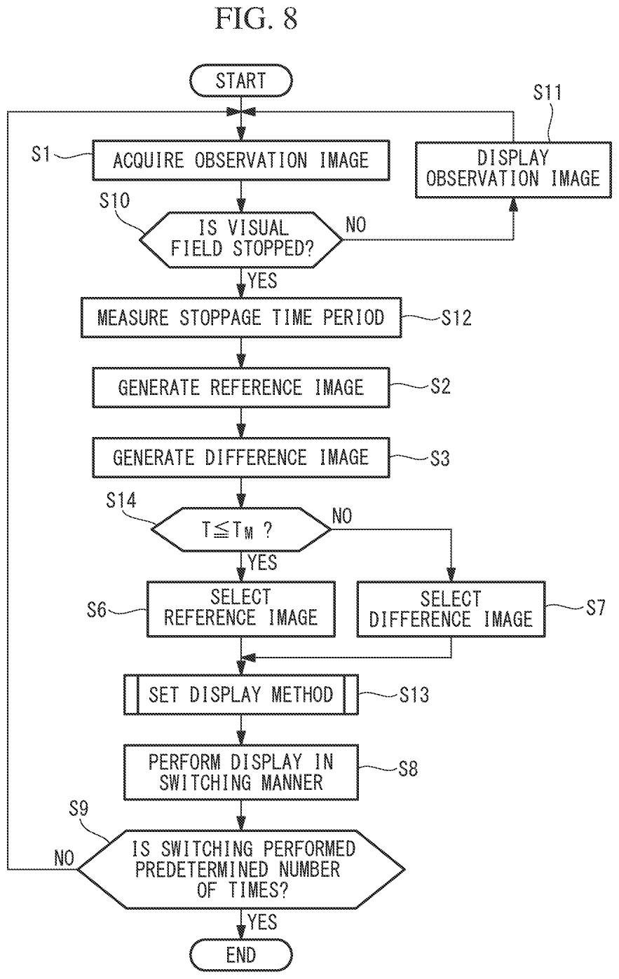

This embodiment is similar to the first embodiment in that an image to be selected as a display image is set in accordance with the magnitude of the difference between the observation image and the reference image. Alternatively, as shown in FIG. 8, an image to be selected as a display image may be set in accordance with the stoppage time period T of the visual field (step S14). In the example shown in FIG. 8, the reference image is selected as a display image if the stoppage time period T is smaller than or equal to the threshold value T_{M}, or the difference image is selected as a display image if the stoppage time period T is greater than the threshold value T_{M}. If the stoppage time period T is greater than the threshold value T_{M}, the reference image and the difference image may be selected as display images.

In a state where the stoppage time period is long and the determination is difficult, it can be confirmed the extent to which a minor abnormality within the observation image appears as a difference. Directly reviewing the difference from the correct pattern facilitates the ultimate determination. The threshold value used for selecting a display image may be a freely-chosen value.

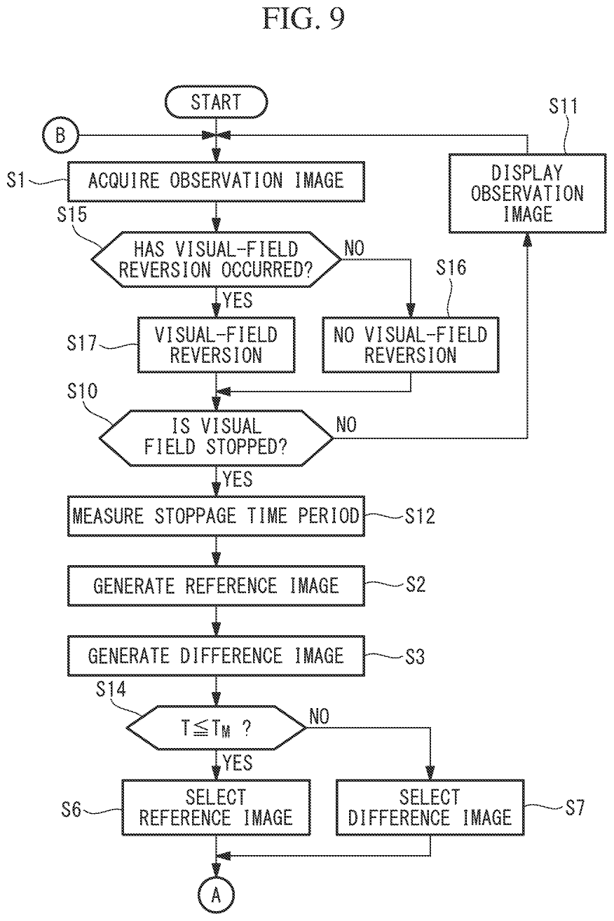

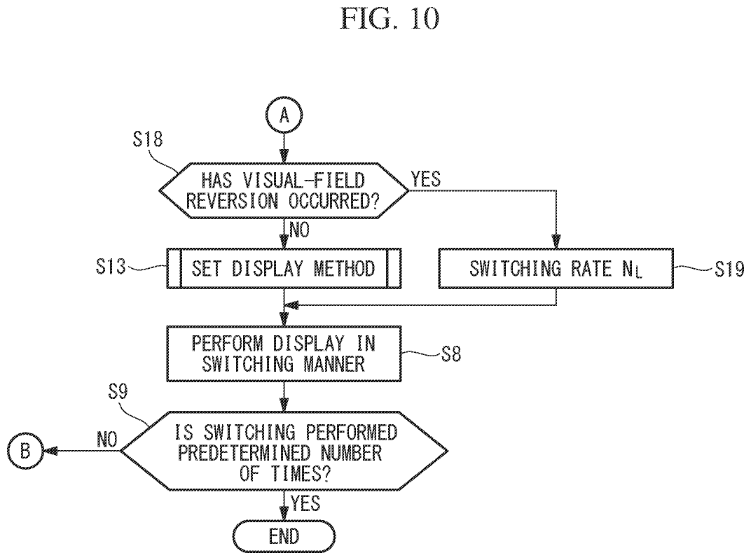

In addition to monitoring the stoppage and the stoppage time period of the visual field, the visual-field shift monitoring unit 22 may monitor whether or not there is a visual-field reversion (step S15), as shown in FIGS. 9 and 10. If the visual field has shifted in a predetermined shift pattern, a “no visual-field reversion” is confirmed (step S16). If the visual field reverts to an observation visual field previously used for observation, a “visual-field reversion” is confirmed (step S17).

If a visual-field reversion has occurred (step S18), the display may be switched at the highest rate (step S19), unlike a display method used when a visual-field reversion has not occurred. Since a state where a visual-field reversion has occurred is a state where the determination is difficult, an abnormality can be found readily by using the same setting as in the case where the stoppage time period is the longest.

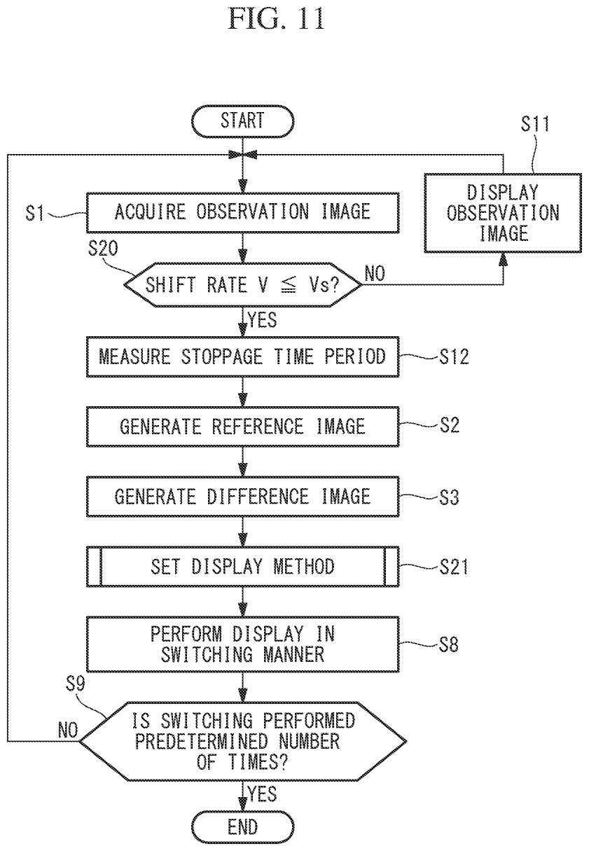

Furthermore, as shown in FIG. 11, the visual-field shift monitoring unit 22 may monitor the shift rate of the visual field (step S20). It may be determined whether or not a shift rate V is lower than or equal to a predetermined threshold value Vs (step S20). If the shift rate V is lower than or equal to a predetermined threshold value Vs, the control unit 3 is caused to start generating a reference image, a difference image, and a display image and to start displaying the observation image and the display image in a switching manner. If the shift rate V is higher than the threshold value Vs, the control unit 3 receives a command for displaying the observation image on the display unit 4 (step S11).

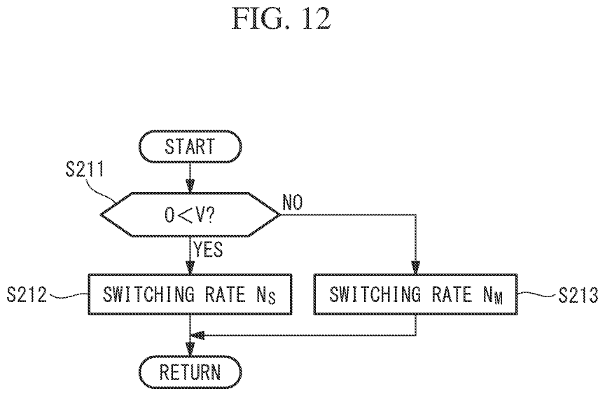

When the display controller 11 receives information about the shift rate V from the visual-field shift monitoring unit 22, the display controller 11 sets a display method in accordance with the magnitude of the shift rate V (step S21). In detail, as shown in FIG. 12, it is determined whether or not the shift rate V is higher than zero (step S211). If the shift rate V is higher than zero (i.e., 0<V≤Vs), the display controller 11 switches between the observation image and the display image at the switching rate Nₛ (step S212). When the shift rate V is equal to zero, that is, when the visual field is in a stopped state, the display controller 11 switches between the observation image and the display image at the switching rate N_{M} (step S213).

The moving speed of the stage may start to decrease when, for example, an image different from a normal image is found within the visual field. In this case, the observation image and the display image are displayed in a switching manner to prevent an oversight, thereby achieving improved conspicuity.

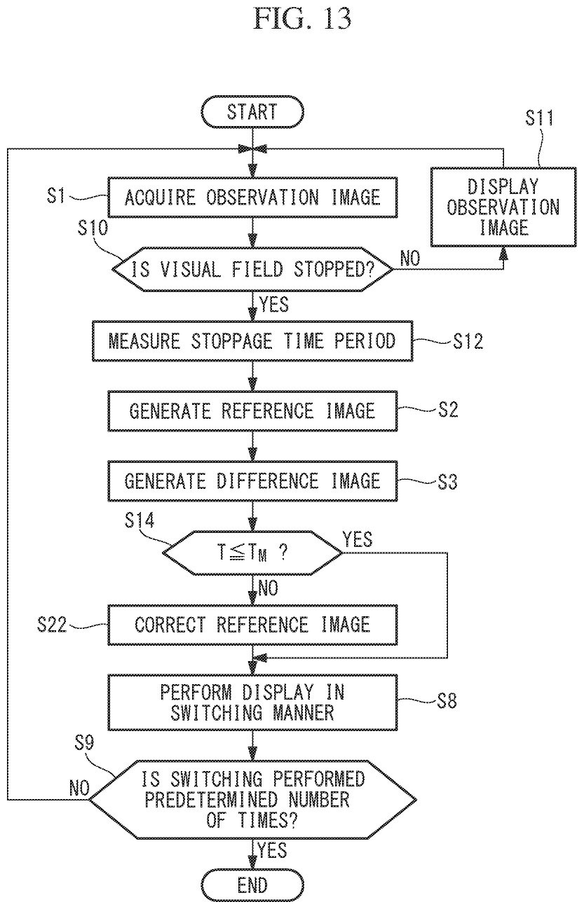

As an alternative to the above example where the display controller 11 changes the switching rate in accordance with the stoppage time period, the display image generator (image corrector) 9 may correct the difference image serving as a display image in accordance with the length of the stoppage time period when the display image generator 9 receives information about the stoppage time period from the visual-field shift monitoring unit 22, as shown in FIG. 13. In detail, as shown in FIG. 13, it is determined whether or not the stoppage time period T is smaller than or equal to the threshold value T_{M} (step S14). If the stoppage time period T is smaller than or equal to the threshold value T_{M}, the display image is not to be corrected. If the stoppage time period T is greater than the threshold value T_{M}, the display image generator 9 corrects the display image (step S22).

The correction of the display image is performed on, for example, the chroma or the contrast. Increasing the chroma or the contrast allows for improved conspicuity. Furthermore, the display image generator (difference calculator) 9 may calculate the magnitude of the difference between the observation image and the reference image, and may change the correction level of the chroma or the contrast based on the magnitude of the difference. Increasing the chroma or the contrast with decreasing difference allows for improved conspicuity even for an abnormality such as a minor scratch. If the subject is monotonous, a correction process of adding a false color or colors may be performed. Moreover, the reference image may be corrected without generating a difference image.

As a result, the above-described embodiments lead to the follwoing aspects.

An aspect of the present invention is directed to an observation device including: a photographing unit that acquires an observation image by photographing a subject; a reference image generator that generates a reference image, in which an abnormality has been eliminated as compared with the observation image, based on the acquired observation image; and a display unit that displays the generated reference image and the observation image in a switching manner.

According to this aspect, when the photographing unit acquires the observation image, the reference image generator generates the reference image based on the acquired observation image, and the display unit displays the reference image and the observation image in a switching manner. If the observation image contains an abnormality, the observation image and the reference image, which does not include an abnormality therein as compared with the observation image, are displayed in a switching manner, thereby achieving improved conspicuity for drawing the attention of the observer to the location of the abnormality by utilizing persistence of vision.

Since the reference image is an image in which the abnormality has been eliminated as compared with the acquired observation image, the photographing conditions completely match those for the observation target, so that the problem of mismatch does not occur during the comparison. Accordingly, the need for adjusting the photographing conditions can be eliminated when the observation image and the reference image are to be acquired, and the observer can simply and accurately be notified of the location where the abnormality has occurred in the subject.

Another aspect of the present invention is directed to an observation device including: a photographing unit that acquires an observation image by photographing a subject; a reference image generator that generates a reference image, in which an abnormality has been eliminated as compared with the observation image, based on the acquired observation image; a difference image generator that generates a difference image between the generated reference image and the observation image; and a display unit that displays the generated difference image and the observation image in a switching manner.

According to this aspect, when the photographing unit acquires the observation image, the reference image generator generates the reference image based on the acquired observation image, the difference image generator generates the difference image between the reference image and the observation image, and the display unit displays the difference image and the observation image in a switching manner. If the observation image contains an abnormality, the location of the abnormality can be made more obvious in accordance with the difference image between the observation image and the reference image, which does not include an abnormality therein as compared with the observation image, thereby achieving improved conspicuity for drawing the attention of the observer to the location of the abnormality in accordance with the switching display.

Another aspect of the present invention is directed to an observation device including: a photographing unit that acquires an observation image by photographing a subject; a reference image generator that generates a reference image, in which an abnormality has been eliminated as compared with the observation image, based on the acquired observation image; a difference calculator that calculates a magnitude of a difference between the generated reference image and the observation image; an image corrector that generates a correction image by adjusting a color attribute or brightness of the reference image based on the calculated magnitude of the difference; and a display unit that displays the generated correction image and the observation image in a switching manner.

According to this aspect, when the photographing unit acquires the observation image, the reference image generator generates the reference image based on the acquired observation image, and the difference calculator calculates the magnitude of the difference between the reference image and the observation image. Then, the image corrector generates the correction image by adjusting the color attribute or brightness of the reference image based on the magnitude of the difference, and the display unit displays the correction image and the observation image n a switching manner. If the difference is small, the location of the abnormality can be made more obvious by adjusting the color attribute, such as the chroma or the contrast, or the brightness, and improved conspicuity for drawing the attention of the observer to the location of the abnormality can be achieved in accordance with the switching display.

Furthermore, in the above aspect, the observation device may further include: a visual-field shift-status detector that detects a shift status of an observation visual field by the photographing unit; and a display adjuster that adjusts a display switching pattern in the display unit based on the detected shift status of the observation visual field.

With this configuration, the display adjuster adjusts the display switching pattern based on the shift status of the observation visual field. Specifically, when the observer is observing the observation image while shifting the observation visual field, if the observation visual field being displayed is suspected to have a location with an abnormality, the shift status of the observation visual field changes. Accordingly, improved conspicuity for drawing the attention of the observer to the location of the abnormality can be achieved by adjusting the switching pattern based on the shift status.

Furthermore, in the above aspect, the shift status of the observation visual field may be a stoppage of the observation visual field, a change in a shift rate, or a visual-field reversion in which the visual field reverts to the observation visual field previously used for observation.

With this configuration, when the observation visual field is stopped, when the shift rate decreases, or when a visual-field reversion where the visual field reverts to the observation visual field previously used for observation occurs, it can be determined that the observation visual field being displayed is suspected to have a location with an abnormality. Accordingly, improved conspicuity for drawing the attention of the observer to the location of the abnormality can be achieved by adjusting the switching pattern.

Furthermore, in the above aspect, the switching pattern may be a switching rate.

With this configuration, an after-image remains longer with increasing switching rate, thereby achieving improved conspicuity for drawing the attention of the observer to the location of the abnormality.

Furthermore, in the above aspect, the switching of the display may be performed a plurality of times, and the switching pattern may be the number of times the switching is performed.

Furthermore, in the above aspect, the reference image generator may generate the reference image based on a teaching process.

With this configuration, the reference image can be readily generated. For example, the reference image can be generated by preliminarily learning a non-abnormal pattern alone so as to input the observation image to a network that has extracted a feature quantity with which the non-abnormal pattern is reproducible.

Another aspect of the present invention provides an observation method including: acquiring an observation image by photographing a subject; generating a reference image, in which an abnormality has been eliminated as compared with the observation image, based on the acquired observation image; and displaying the generated reference image and the observation image in a switching manner.

Another aspect of the present invention provides an observation method including: acquiring an observation image by photographing a subject; generating a reference image, in which an abnormality has been eliminated as compared with the observation image, based on the acquired observation image; generating a difference image between the generated reference image and the observation image; and displaying the generated difference image and the observation image in a switching manner.

Another aspect of the present invention provides an observation method including: acquiring an observation image by photographing a subject; generating a reference image, in which an abnormality has been eliminated as compared with the observation image, based on the acquired observation image; calculating the magnitude of a difference between the generated reference image and the observation image; generating a correction image by adjusting a color attribute or brightness of the reference image based on the calculated magnitude of the difference; and displaying the generated correction image and the observation image in a switching manner.

The present invention is advantageous in that it eliminates the need for adjusting photographing conditions when an observation image and a reference image are to be acquired, and that it can simply and accurately notify an observer of a location where an abnormality has occurred in a subject.

### REFERENCE SIGNS LIST

1, 21 observation device
2 image acquisition unit (photographing unit)
4 display unit
7 reference image generator
8 difference image generator
9 display image generator (image corrector, difference calculator)
11 display controller (display adjuster)
22 visual-field shift monitoring unit (visual-field shift-status detector)

1. An observation device comprising:
a camera that acquires an observation image by photographing a subject;
one or more processors comprising hardware, the one or more processors being configured to: generate a reference image by performing image processing on the acquired observation image for eliminating an abnormality in the observation image; and
a display that displays the generated reference image and the observation image in a switching manner.

2. An observation device comprising:
a camera that acquires an observation image by photographing a subject;
one or more processors comprising hardware, the one or more processors being configured to:
generate a reference image, in which an abnormality has been eliminated as compared with the observation image, based on the acquired observation image; and
generate a difference image between the generated reference image and the observation image; and
a display that displays the generated difference image and the observation image in a switching manner.

3. An observation device comprising:
a camera that acquires an observation image by photographing a subject;
one or more processors comprising hardware, the one or more processors being configured to:
generate a reference image, in which an abnormality has been eliminated as compared with the observation image, based on the acquired observation image;
calculate a magnitude of a difference between the generated reference image and the observation image; and
generate a correction image by adjusting a color attribute or brightness of the reference image based on the calculated magnitude of the difference; and
a display that displays the generated correction image and the observation image in a switching manner.

4. The observation device according to claim 1, wherein the one or more processor is further configured to:
detect a shift status of an observation visual field photographed by the camera; and
adjust a display switching pattern in the display based on the detected shift status of the observation visual field.

5. The observation device according to claim 4,
wherein the shift status of the observation visual field comprises a stoppage of the observation visual field, a change in a shift rate, or a visual-field reversion in which the visual field reverts to the observation visual field previously used for observation.

6. The observation device according to claim 4, wherein the switching pattern comprises a switching rate.

7. The observation device according to claim 4,
wherein the switching of the display is performed a plurality of times, and
wherein the switching pattern comprises a number of times the switching is performed.

8. The observation device according to claim 2, wherein the one or more processor is further configured to:
detect a shift status of an observation visual field photographed by the camera; and
adjust a display switching pattern in the display based on the detected shift status of the observation visual field.

9. The observation device according to claim 8,
wherein the shift status of the observation visual field comprises a stoppage of the observation visual field, a change in a shift rate, or a visual-field reversion in which the visual field reverts to the observation visual field previously used for observation.

10. The observation device according to claim 8, wherein the switching pattern comprises a switching rate.

11. The observation device according to claim 8,
wherein the switching of the display is performed a plurality of times, and
wherein the switching pattern comprises a number of times the switching is performed.

12. The observation device according to claim 3, wherein the one or more processor is further configured to:
detect a shift status of an observation visual field photographed by the camera; and
adjust a display switching pattern in the display based on the detected shift status of the observation visual field.

13. The observation device according to claim 12,
wherein the shift status of the observation visual field comprises a stoppage of the observation visual field, a change in a shift rate, or a visual-field reversion in which the visual field reverts to the observation visual field previously used for observation.

14. The observation device according to claim 12, wherein the switching pattern comprises a switching rate.

15. The observation device according to claim 12,
wherein the switching of the display is performed a plurality of times, and
wherein the switching pattern comprises a number of times the switching is performed.

16. The observation device according to claim 1,
wherein the generating of the reference image inputs the observation image to a network that has extracted a feature quantity with which a non-abnormal pattern is reproducible by preliminarily learning the non-abnormal pattern alone.

17. The observation device according to claim 2,
wherein the generating of the reference image inputs the observation image to a network that has extracted a feature quantity with which a non-abnormal pattern is reproducible by preliminarily learning the non-abnormal pattern alone.

18. The observation device according to claim 3,
wherein the generating of the reference image inputs the observation image to a network that has extracted a feature quantity with which a non-abnormal pattern is reproducible by preliminarily learning the non-abnormal pattern alone.

19. An observation method comprising:
acquiring an observation image by photographing a subject;
generating a reference image by performing image processing on the acquired observation image for eliminating an abnormality in the observation image; and
displaying the generated reference image and the observation image in a switching manner.

20. An observation method comprising:
acquiring an observation image by photographing a subject;
generating a reference image, in which an abnormality has been eliminated as compared with the observation image, based on the acquired observation image;
generating a difference image between the generated reference image and the observation image; and
displaying the generated difference image and the observation image in a switching manner.

21. An observation method comprising:
acquiring an observation image by photographing a subject;
generating a reference image, in which an abnormality has been eliminated as compared with the observation image, based on the acquired observation image;
calculating a magnitude of a difference between the generated reference image and the observation image;
generating a correction image by adjusting a color attribute or brightness of the reference image based on the calculated magnitude of the difference; and
displaying the generated correction image and the observation image in a switching manner.
